(19) United States
(12) Patent Application Publication
(10) Pub. No.: US 2008/0189490 A1
(43) Pub. Date: Aug. 7, 2008

(54) MEMORY MAPPING

(75) Inventors: Won-Moon Cheon, Kwasung-City (KR); Yang-Sup Lee, Seoul (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD., Suwon-si (KR)

(21) Appl. No.: 11/833,750

(22) Filed: Aug. 3, 2007

(30) Foreign Application Priority Data
Feb. 6, 2007 (KR) P2007-0012198

(51) Int. Cl. G06F 13/00

(52) U.S. Cl. 711/144

(57) ABSTRACT

A system and method for memory mapping are provided, the system including a logical unit to physical unit map table, data unit groups in signal communication with the map table, and log unit groups, each associated with a corresponding one of the data unit groups, where updated data for any data unit within one of the data unit groups is stored in any log unit within the corresponding one of the log unit groups, and the method including receiving write data for a logical unit number from a host determining which of a plurality of data block groups comprises the logical unit number, and storing the write data in any unfilled log unit of a log block group corresponding to the determined data block group.

### CROSS-REFERENCE TO RELATED APPLICATION

This application claims foreign priority under 35 U.S.C. §119 to Korean Patent Application No. P2007-0012198 (Atty. Dkt. ID-200610-028), filed on Feb. 6, 2007, in the Korean Intellectual Property Office, the disclosure of which is incorporated by reference herein in its entirety.

### BACKGROUND OF THE INVENTION

The present disclosure generally relates to flash memory systems. More particularly, the present disclosure relates to flash memory systems with mapping tables.

Emerging portable electronic devices, such as computers, digital cameras, digital music players, cellular telephones, personal data assistants, and the like, have made increasing use of flash memories, particularly flash cards. A flash card may be a SSD, SD card, MMC, Memory Stick, or an embedded card such as moviNAND, GBNAND, iNAND and the like.

Hosts generally communicate with flash memories using a flash translation layer (“FTL”). The FTL may include firmware stored in a controller or a flash memory. The FTL is generally used to effectively manage the flash card.

An address mapping operation is a function of the FTL, which receives a logical address (“LA”) from the host and then translates the received LA into a physical address (“PA”), The PA is the address that is actually used to store data within the flash memory and to retrieve data from the flash memory.

An address mapping table may be used to facilitate the address conversion. The table may be stored in the flash memory, and loaded into a buffer within a controller, for example. Logical addresses and corresponding physical addresses are correlated within the table. The size of the table is dependant upon a defined mapping unit. The larger the table size, the greater the required buffer size. Typical mapping units include blocks, which are generally the size of erase units, or pages, which are generally the size of read/write units.

There are several mapping methods usable in correspondence with various mapping units. In a page mapping method, a mapping table is commonly sized for page units. That is, a logical page of data addresses is converted into a corresponding physical page. Here, one memory block may include several tens or hundreds of pages. Unfortunately, this method requires mapping tables of dramatically larger sizes than a block mapping method, for example.

In a block mapping method, a mapping table is commonly sized for block units. Here, pages must be written in sequential order within a block. Unfortunately, a large number of merge operations are required in order to create a free block when using such a method.

### SUMMARY OF THE INVENTION

These and other issues are addressed by a system and method for memory mapping. Exemplary embodiments are provided.

An exemplary method of memory mapping includes receiving write data for a logical unit number from a host, determining which of a plurality of data block groups comprises the logical unit number, and storing the write data in any unfilled log unit of a log block group corresponding to the determined data block group.

Another exemplary method further includes receiving a write request for a second logical unit number from the host, and storing the second logical unit number in association with a second physical unit number in the log block of the log block group.

An exemplary memory mapping system includes input means for receiving write data for a logical unit number from a host, mapping means for determining which of a plurality of data block groups comprises the logical unit number, and memory means for storing the write data in any unfilled log unit of a log block group corresponding to the determined data block group.

An exemplary memory mapping system includes at least one logical unit to physical unit map table, a plurality of data unit groups in signal communication with the at least one map table, and a plurality of log unit groups, each associated with a corresponding one of the plurality of data unit groups, wherein updated data for any data unit within one of the plurality of data unit groups is stored in any log unit within the corresponding one of the plurality of log unit groups.

The present disclosure will be further understood from the following description of exemplary embodiments, which is to be read in connection with the accompanying drawings.

### BRIEF DESCRIPTION OF THE DRAWINGS

The present disclosure provides a system and method for memory mapping in accordance with the following exemplary figures, in which:

FIG. 1 shows a schematic block diagram for a memory mapping system usable in accordance with exemplary embodiments of the present disclosure;

FIG. 2 shows a schematic block diagram for a flash memory card system usable in accordance with exemplary embodiments of the present disclosure;

FIG. 3 shows a schematic block diagram for a hybrid mapping system in accordance with an exemplary embodiment of the present disclosure;

FIG. 4 shows a schematic block diagram for a merge sequence in accordance with an exemplary embodiment of the present disclosure;

FIG. 5 shows a schematic block diagram for a hybrid mapping system with group mapping table in accordance with an exemplary embodiment of the present disclosure;

FIG. 6 shows a schematic block diagram for a group mapping flash translation layer in accordance with an exemplary embodiment of the present disclosure;

FIG. 7 shows a schematic block diagram for a logical flash memory structure in accordance with an exemplary embodiment of the present disclosure;

FIG. 8 shows a schematic block diagram for a page mapping structure in accordance with an exemplary embodiment of the present disclosure;

FIG. 9 shows a schematic block diagram for a block mapping structure in accordance with an exemplary embodiment of the present disclosure;

FIG. 10 shows a schematic block diagram for a hybrid mapping structure in accordance with an exemplary embodiment of the present disclosure;

FIG. 11 shows a schematic block diagram for a merge method in accordance with an exemplary embodiment of the present disclosure;

FIG. 12 shows a schematic block diagram for a copy-merge method in accordance with an exemplary embodiment of the present disclosure;

FIG. 13 shows a schematic block diagram for a swap-merge method in accordance with an exemplary embodiment of the present disclosure;

FIG. 14 shows a schematic block diagram for a 1:1 mapping structure in accordance with an exemplary embodiment of the present disclosure:

FIG. 15 shows a schematic block diagram for a 1:2 mapping structure in accordance with an exemplary embodiment of the present disclosure;

FIG. 16 shows a schematic block diagram for a 1:N mapping structure in accordance with an exemplary embodiment of the present disclosure; and

FIG. 17 shows a schematic block diagram for an N:M+K mapping structure in accordance with an exemplary embodiment of the present disclosure.

### DETAILED DESCRIPTION OF PREFERRED EMBODIMENTS

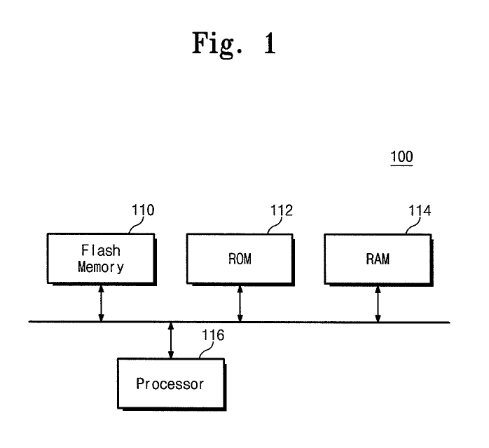

As shown in FIG. 1, a memory mapping system is indicated generally by the reference numeral 100. The system 100 includes a processor 116, a flash memory 110 in signal communication with the processor, a read-only memory (“ROM”) 112 in signal communication with the processor, and a random access memory (“RAM”) 114 in signal communication with the processor. The ROM 112, for example, may include program steps executable by the processor 116 for providing read and write commands to read data from and write data to the flash memory 110 or the RAM 114. The read and write operations responsive to the commands are performed in the flash memory 110 in accordance with memory mapping embodiments of the present disclosure In addition, the ROM 112 and the RAM 114 may store related data structures and/or application program steps executable by the processor 116.

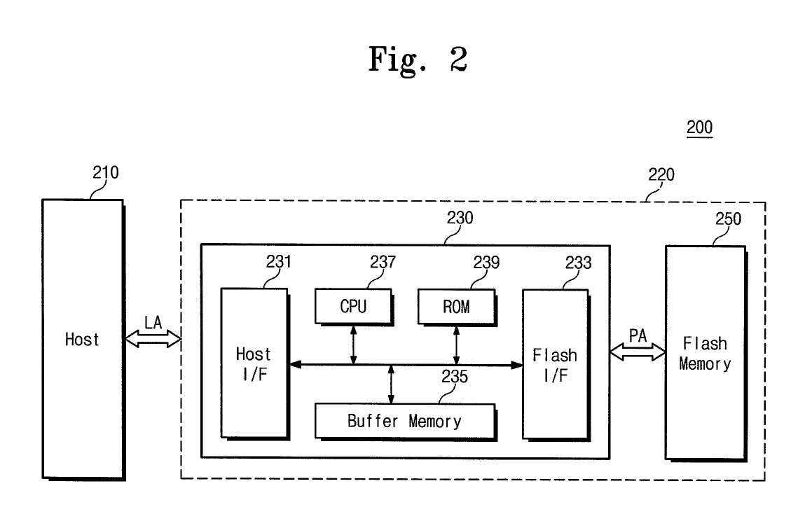

Turning to FIG. 2, a flash memory card system is indicated generally by the reference numeral 200. The system 200 may be a portable electronic device, such as a computer, digital camera, digital music player, cellular telephone, personal data assistant (“PDA”), or the like. The system 200 includes a host 210 in signal communication with a flash card 220. The flash card 220 may be a solidstate disk (“SSD”), SD card, MMC, Memory Stick, an embedded card such as moviNAND, GBNAND, iNAND, or the like.

The flash card 220 includes a controller 230 in signal communication with a flash memory 250. The host 210 communicates with the flash memory 250 using a flash translation layer (“FTL”), which may include logic and/or firmware used to effectively manage the card 220. The FTL may be stored or implemented in the controller 230 or in the flash memory 250.

The controller 230 includes a host interface 231 in signal communication with a controller bus 232, a flash interface 233 in signal communication with the controller bus 232, a buffer memory 235 in signal communication with the controller bus 232, a CPU 237 in signal communication with the controller bus 232, and a ROM 239 in signal communication with the controller bus 232.

In operation, an address mapping operation is a function of the FTL, which receives a logical address (“LA”) from the host 210, and then translates the received LA into a physical address (“PA”). The PA is the address that is actually used to store data within the flash memory 250. An address mapping table may be used to facilitate the LA to PA address conversion. Logical addresses and corresponding physical addresses are correlated within the table. The table may be stored in the flash memory 250 and loaded to the buffer 235 within the controller 230. The size of the table is dependant upon a defined mapping unit.

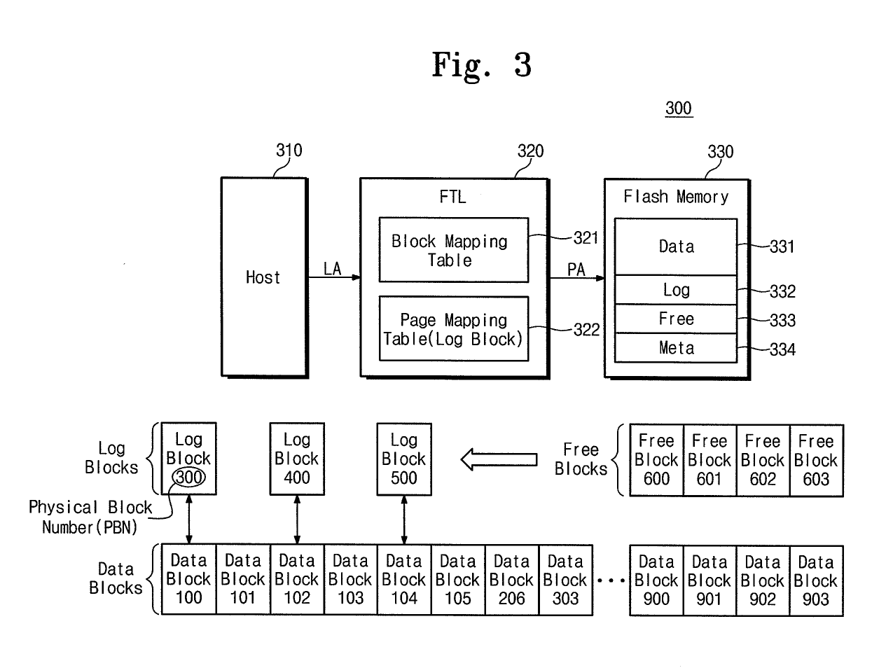

Turning now to FIG. 3, a hybrid mapping system is indicated generally by the reference numeral 300. The system 300 includes a host 310 in signal communication with a FTL 320, which, in turn, is in signal communication with a flash memory 330. A logical address (“LA”) is passed between the host 310 and the FTL 320. A physical address (“PA”) is passed between the FTL 320 and the flash memory 330. The FTL 320 includes a block mapping table 321 and a page mapping table 322. The page mapping table may be implemented for the log blocks, while the block mapping table may be implemented for the data blocks, for example.

The flash memory 330 includes a data region 331, which here includes data blocks having physical block numbers (“PBN”) 100, 101, 102, 103 104, 105, 206, 303, . . . , 900, 901, 902 and 903. The flash memory 330 also includes a log region 332, which here includes log blocks having PIBNs 300, 400 and 500. The flash memory 330 further includes a free region 333, which here includes free blocks 600, 601, 602 and 603. In addition, the flash memory 330 includes a meta region 334.

In operation, a hybrid mapping method may be used for mapping addresses in flash card systems, for example. In the hybrid mapping method, the mapping table may correlate logical addresses with physical addresses for both page units and block units. When the hybrid mapping method is used for page mapping of log blocks and block mapping of data blocks, the size of table and the number of merge operations may each be reduced.

When performing a write operation, for example, page data to be stored in a designated data block is first stored in an assigned log block. If there are no free blocks to be used as the log block, the FTL performs a merge operation. In the merge operation, page data in the log block and page data in the data block corresponding to the log block are stored or copied into a new data block. The mapping information changed during the operations is stored in a meta block. The log block and the old data block may be safely erased once the contents are assigned to other blocks.

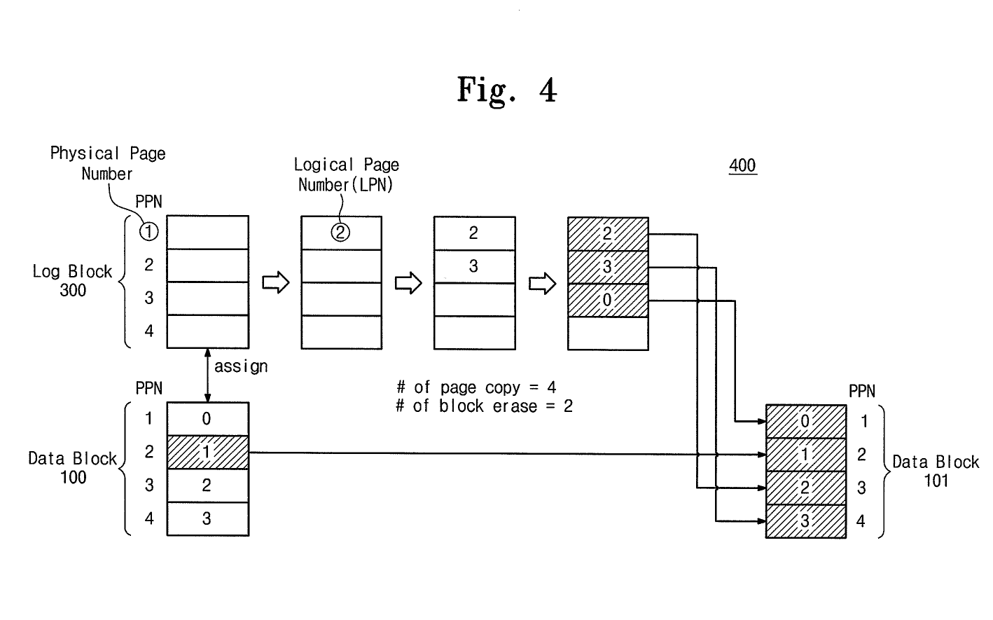

As shown in FIG. 4, a merge sequence is indicated generally by the reference numeral 400. The merge 400 receives a data block 100 and a log block 300, and provides a merged data block 101. Here, when data corresponding to logical page number (“LPN”) 1 has been stored in physical page number (“PPN”) 2 of data block 100, and the host requests write operations in order of LPNs 2, 3 and 0, PPNs 1, 2 and 3 of log block 300 are written in sequence. When the FTL performs a merge operation of log block 300, such as because of a shortage of free blocks, LPNs 2, 3 and 0 of the log block 300 and LPN 1 of the corresponding data block 100 are copied into PPNs 1, 2, 3 and 4, respectively, of new data block 101 in order of LPN 0, 1, 2 and 3. The log block 300 and the data block 100 are erased when re-assigned, such as for new log blocks or free blocks.

This method uses many page copy and block erase operations Assuming that one block consists of four pages, four page copy operations and two block erase operations are required per one merge operation. Further, this method has low page use rates within log blocks. The log block 300 uses only three pages out of 4 pages before it is converted to a free block by merge. The many copy and erase operations for frequent merge operations, and the low page usage rates, lead to a decrease in the overall performance of the card system.

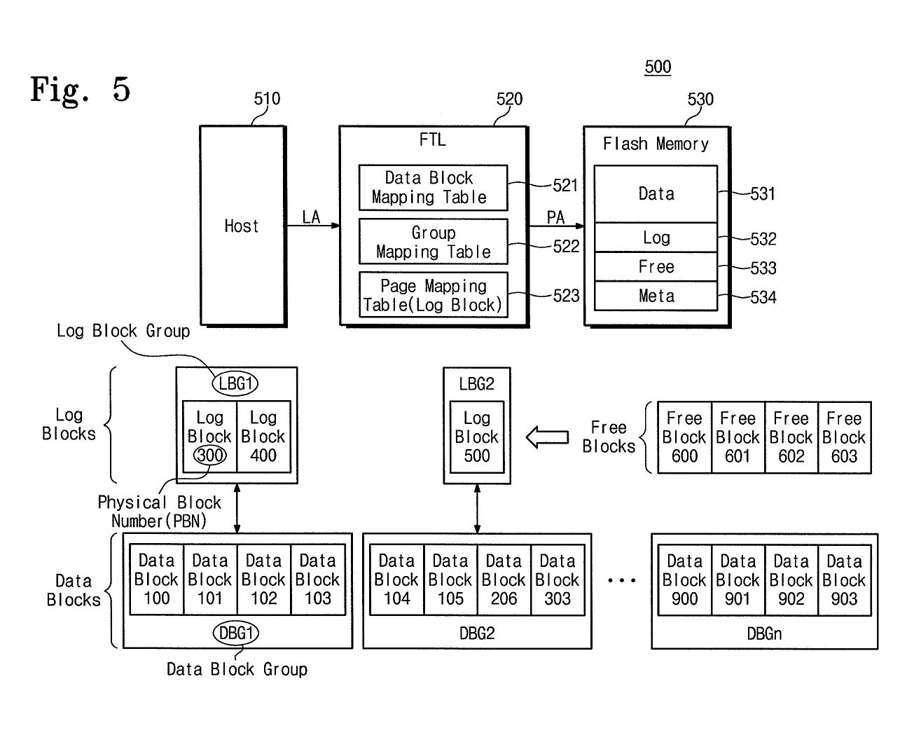

Turning to FIG. 5, a hybrid mapping system with group mapping table is indicated generally by the reference numeral 500. The system 500 includes a host 510 in signal communication with a FTL 520, which, in turn, is in signal communication with a flash memory 530. A logical address (“LLA”) is passed between the host 510 and the FTL 520. A physical address (“PA”) is passed between the FTL 520 and the flash memory 530. The FTL 520 includes a block mapping table 521, a group mapping table 522 and a page mapping table 523. The page mapping table may be implemented for the log blocks, while the block mapping table may be implemented for the data blocks, for example.

The flash memory 530 includes a data region 531, which here includes data blocks having physical block numbers (“PBN”) 100, 101, 102, 103, 104, 105, 206, 303, . . . , 900, 901, 902 and 903. The data blocks are distributed among data block groups. The flash memory 530 also includes a log region 532, which here includes log blocks having PBNs 300, 400 and 500. The log blocks are distributed among log block groups. The flash memory 530 further includes a free region 533, which here includes free blocks 600, 601, 602 and 603. In addition, the flash memory 530 includes a meta region 534.

In operation, a log block group (“LBG”) is assigned to a data block group (“DBG”) in a group mapping method. The LBG and DBG include a plurality of log blocks and a plurality of data blocks, respectively. Here, LBG1 consists of log blocks 300 and 4001 and is assigned to DBG1. DBG1 consists of data blocks 100, 101, 102 and 103. Thus, data programmed to data blocks 100-103 is first programmed to log block 300 or 400. Each log block within a LBG can be assigned to any or all data blocks within an assigned DBG. The number of blocks within each DBG or LBG is variable. By the group mapping method, the number of merge operations may be reduced, and the average page use rate within log blocks may be improved.

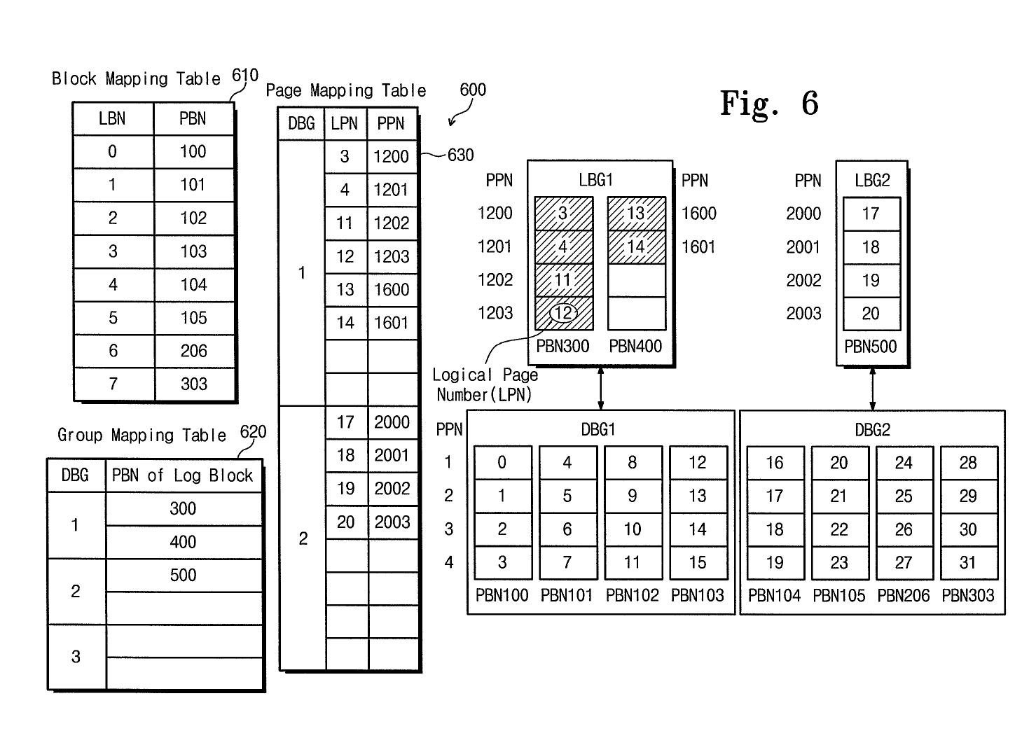

Turning now to FIG. 6, a group mapping flash translation layer (“FTL”) is indicated generally by the reference numeral 600. In this embodiment, the FTL 600 includes a block mapping table (“BMT”) 610, a group mapping table (“GMT”) 620 and a page mapping table (“PMT”) 630. Here, the block mapping table 610 correlates LBNs 0-7 with PBNs 100-105, 206 and 303, respectively. The group mapping table 620 correlates DBG1 with log block PBNs 300 and 400 and DGB2 with log block PBN 500. The page mapping table 630 correlates logical page numbers (“LPNs”) 3, 4, 11, 12, 13 and 14 with physical page numbers (“PPNs”) 1200, 1201, 1202, 1203, 1600 and 1601, respectively, for DBG1. In addition, the page mapping table 630 correlates LPNs 17-20 with PPNs 2000-2003, respectively, for DBG2.

Thus, PBN300 of LBG1 has PPNs 1200-1203 correlated with LPNs 3, 4, 11 and 12, respectively. PBN400 of LBG1 has PPNs 1600-1601 correlated with LPNs 13 and 14, respectively, LBGS is correlated with DBG1. PBN100 of DBG1 has PPNs 1-4 correlated with LPNs 0-3. PBN101 of DBG1 has PPNs 1-4 correlated with LPNs 4-7. PBN102 of DBG1 has PPNs 1-4 correlated with LPNs 8-11. PBN103 of DBG1 has PPNs 1-4 correlated with LPNs 12-15.

In addition, PBN500 of LBG2 has PPNs 2000-2003 correlated with LPNs 17-20, respectively, LBG2 is correlated with DBG2. PBN104 of DPG2 has PPNs 1-4 correlated with LPNs 16-19. PBN105 of PBG2 has PPNs 1-4 correlated with LPNs 20-23. PBN206 of DPG2 has PPNs 1-4 correlated with LPNs 24-27. PBN303 of DBG2 has PPNs 1-4 correlated with LPNs 28-31.

Thus, the block mapping table 610 converts a logical block number (“LBN”) to a physical block number (“PBN”). The group mapping table 620 has mapping information between each DPG and PBNs of log blocks corresponding to the DBG. The page mapping table 630 has mapping information among each DGB, LPNs and corresponding PPNs.

In operation of this exemplary group mapping embodiment, write requests for LPNs 3 and 4 are received from the host. The FTL assigns a log block 300 from the free blocks and creates LBG1 corresponding to DBG1. The FTL enrolls the log block 300 in the group mapping table. The log block 300 may be assigned to all data blocks within the DPG1. Here. LPNs 0-15 can be stored in the log block 300. LPNs 3 and 4 are stored in PPNs 1200 and 1201 of the log block 300. The mapping information is stored in the page mapping table.

Next, write requests for LPNs 11-14 are received from the host. LPNs 11 and 12 are stored in PPNs 1202 and 1203 of the previously assigned log block 300. The page mapping table 630 is updated according to the new mapping information.

A new log block 400 is additionally assigned to the LBG1 to store LPNs 13 and 14. The FTL enrolls the log block 400 in the group mapping table 620. LPNs 13 and 14 are stored in PPNs 1600 and 1601 of the log block 400, and the PMT 630 is updated. Write requests arrive for LPNs 17-20 from the host.

The LPNs 17-20 cannot be stored in the log block 400 because they don't belong to DBG1. The FTL assigns a new log block 500 from the free blocks, and creates LBG2 corresponding to DBG2. The FTL enrolls the log block 500 in the group mapping table 620. The LPNs 16-31 can be stored in the log block 500. LPNs 17-20 are stored in PPNs 2000-2001 of the log block 500, and the PMT 630 is updated.

The page use rates of log blocks improve using the group mapping method. This in contrast to conventional methods in which the log block 300 might use only one page, such as PPN 1200, for example. In the present embodiment, the log block 300 uses all pages, such as PPN 1200-1203, because one log block is assigned to all data blocks within a data block group. In addition, the number of merge operations is reduced in correspondence with the higher page use rates of the log blocks. Further, the number of copy and erase operations is reduced, and system performance improves.

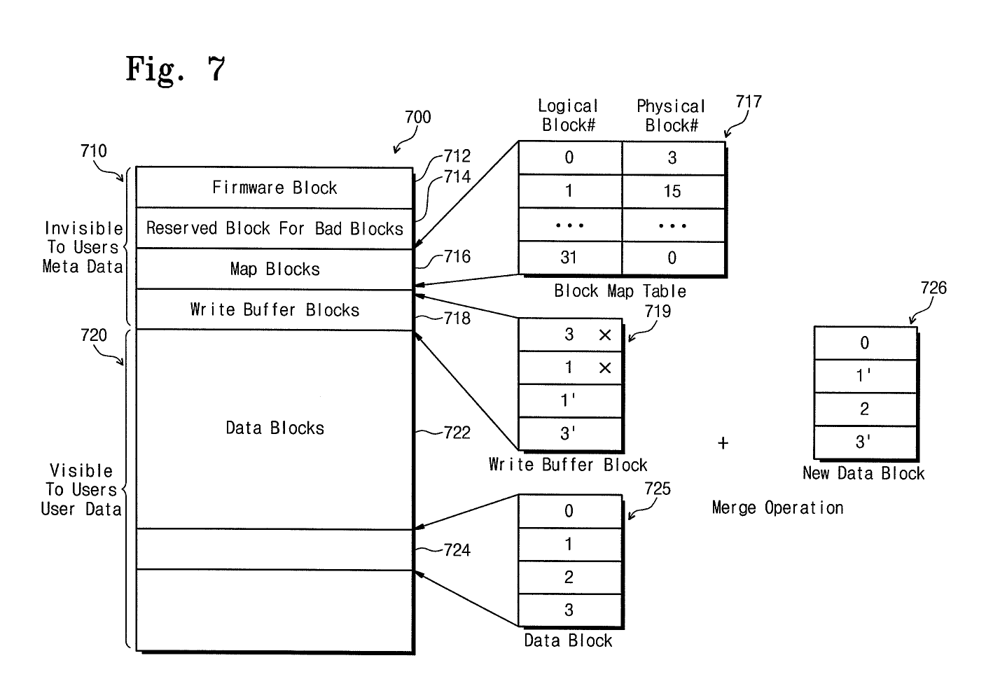

As shown in FIG. 7, a logical flash memory structure is indicated generally by the reference numeral 700. The flash memory 700 includes a meta data area 710, which is invisible to users and a user data area 720, which is visible to users. The meta data area 710 includes firmware blocks 712 reserved blocks 714 that may be used to replace bad blocks, MAP blocks 716 and write buffer blocks 718. The MAP blocks 716 include a block map table 717, which maps logical block numbers 0, 1 . . . 31 to physical block numbers 3, 15 . . . 0, respectively. The write buffer blocks 718 include a write buffer block 719, which here stores replacement data for logical page numbers 1 and 3, namely 1′ and 3′.

The user data area 720 includes data blocks 722-726. A data block 725 includes logical page numbers 0, 1, 2 and 3. In operation, a merge operation combines the data block 725 with the write buffer block 719 to form a new data block 726. Here, the new data block 726 includes logical page numbers 0, 1′, 2 and 3′.

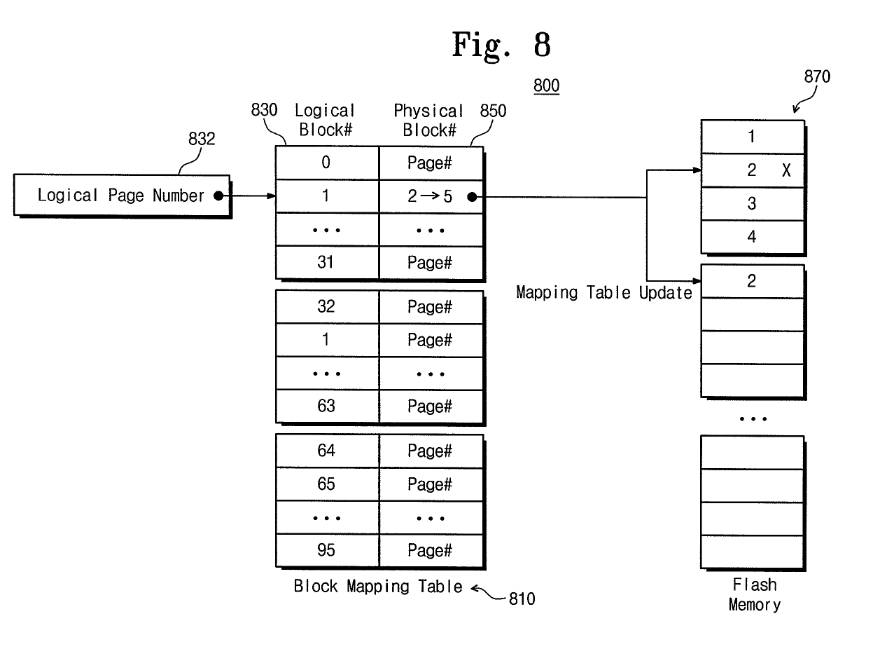

Turning to FIG. 8, a page mapping structure is indicated generally by the reference numeral 800. The page mapping structure 800 includes a page map table 810 and a flash memory 870. The page map table 810 includes logical page numbers 830 and corresponding physical page numbers 850. A logical page number 832 is used to look up the corresponding physical page number.

In operation, logical page number (“LPN”) 1 initially corresponds to physical page number (“PPN”) 2. New PPN 5 is written in the flash memory 870, and the table 810 is updated to associate LPN 1 with PPN 5. This may be referred to as out-of-place mapping. An updating page may be written to a different location of a new block. A page map table update uses a relatively large map table size as overhead. For example, a 128 KB map table is used for a 128 MB NAND flash memory.

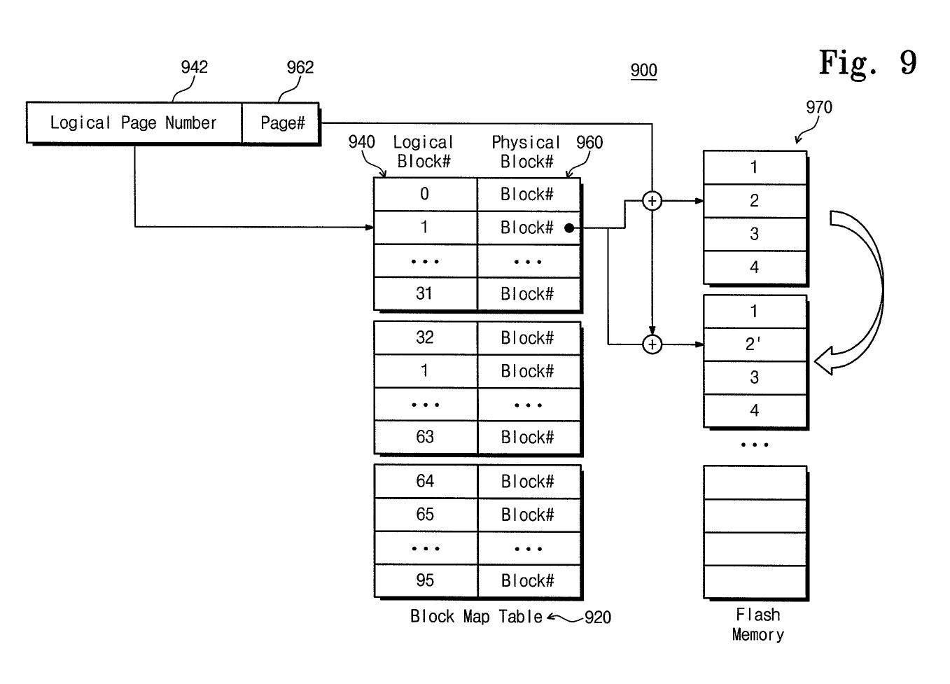

Turning now to FIG. 9, a block mapping structure is indicated generally by the reference numeral 900. The block mapping structure 900 includes a block map table 920 and a flash memory 970. The block map table 920 includes logical block numbers 940 and corresponding physical block numbers 960. A logical block number 942 is used to look up the corresponding physical block number. A physical page number 962 is the offset added to the physical block number.

In operation, physical page number (“PPN”) 2 is updated as PPN 2′ in the flash memory 970. This may be referred to as in-place mapping. Here, the updating page is written to the same location of a new block and the block map table is updated. There is copy overhead during write operation when an out-of-place page update causes a block copy operation.

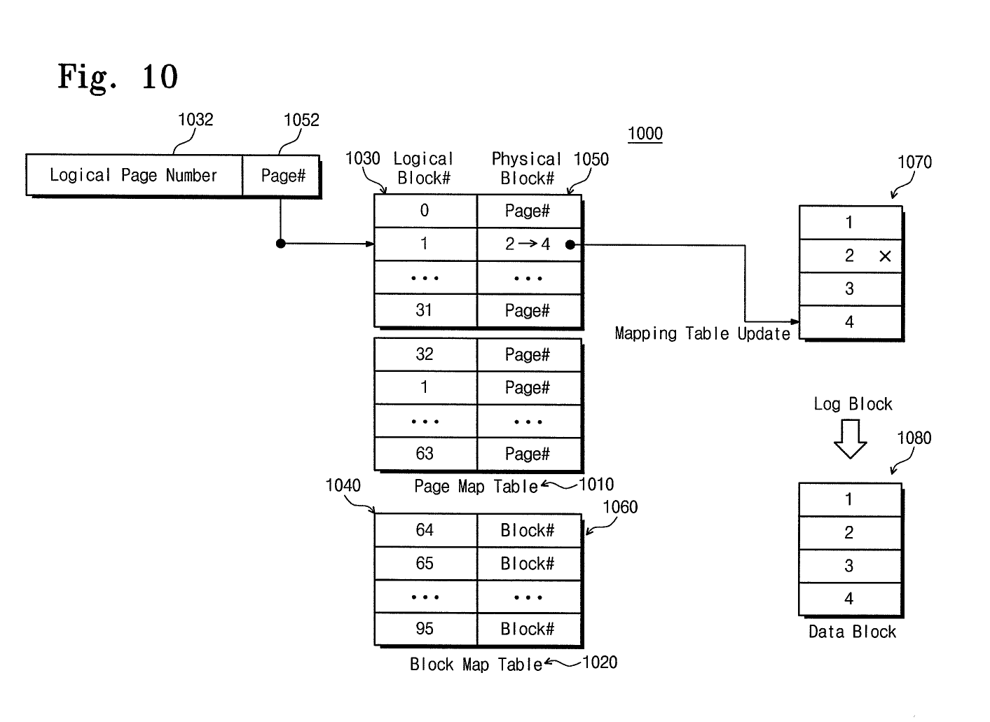

As shown in FIG. 10, a hybrid mapping structure is indicated generally by the reference numeral 1000. The hybrid mapping structure 1000 includes a page map table 1010, a block map table 1020, a log block 1070 and a data block 1080.

The page map table 1010 includes logical page numbers 1030 and corresponding physical page numbers 1050. The block map table 1020 includes logical block numbers 1040 and corresponding physical block numbers 1060. A logical block number 1032 is used to look up the corresponding physical block number.

In operation, a logical block number 1032 is used to look up the corresponding physical block number in the block mapping table 1020, or a logical page number 1052 is used to look up the corresponding physical page number in the page mapping table 1010.

For example, page mapping may be used for a write buffer or log block, while block mapping may be used for a data block. When a logical page number 1 initially corresponds with a physical page number 2 in the log block 1070, the page map table 1010 may be updated to switch logical page number 1 to correspond to physical page number 4. The block map table may be updated when the log block 1070 is used to write to the data block 1080.

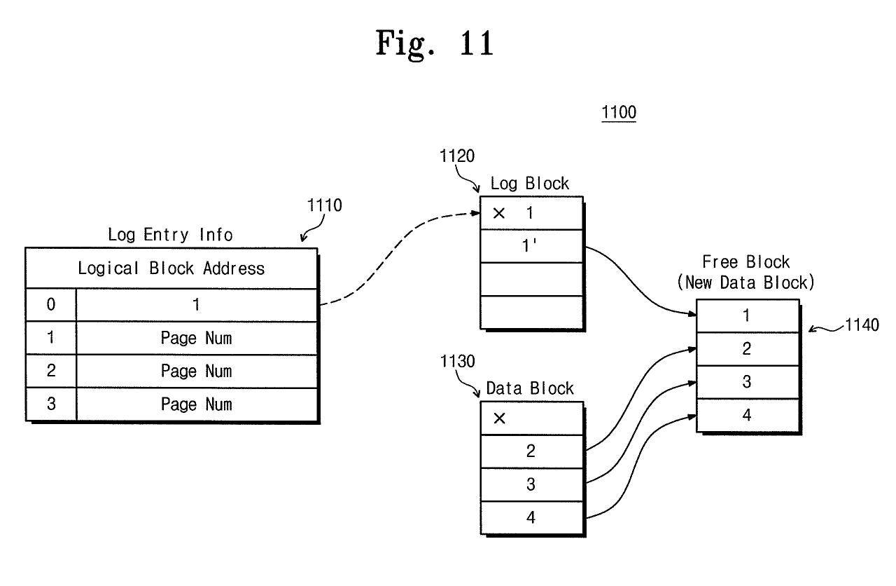

Turning to FIG. 11, a merge method is indicated generally by the reference numeral 1100. Here, log entry information 1110 is used to update a log block 1120 The log block 1120 is then merged with a data block 1130. The merged data is written to a free block 1140, which becomes the new data block. Thus, the merge method 1100 allocates a free block and copies valid pages to the allocated free block, updates the map page by setting the allocated free block as a data block, and sets the old log block and old data block as erasable.

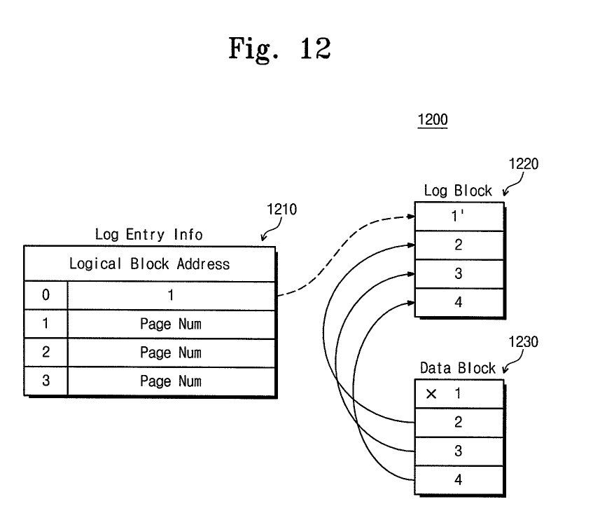

Turning now to FIG. 12, a copy-merge method is indicated generally by the reference numeral 1200. Here, log entry information 1210 is used to update a page of a log block 1220. Unchanged pages of a data block 1230 are copied to the log block 1220. Thus, the merge method 1200 copies valid pages in a d data block to a log block, updates the map page by setting the old log block as the data block, and sets the old data block as erasable.

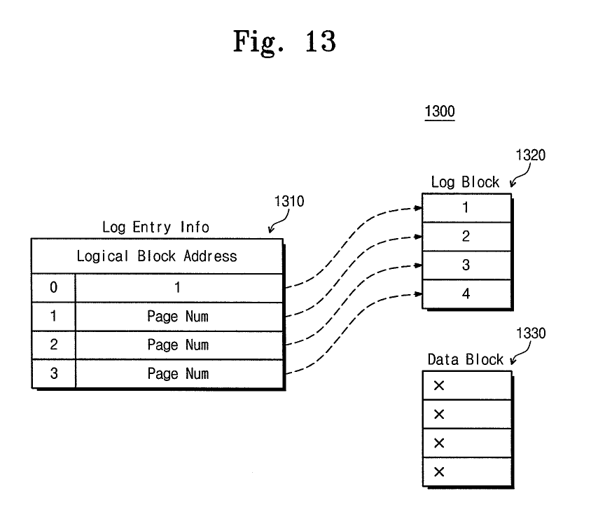

As shown in FIG. 13, a swap-merge method is indicated generally by the reference numeral 1300. Here, log entry information 1310 is used to update all pages of a log block 1320. The map page is updated by setting the old log block as the data block, and the old data block is set as erasable.

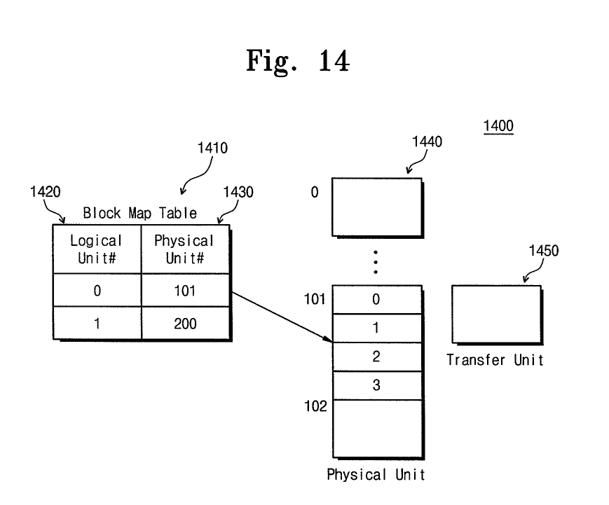

Turning to FIG. 14, a 1:1 mapping structure is indicated generally by the reference numeral 1400. The 1:1 structure 1400 includes a unit map table 1410, which has a logical unit number portion or column 1420 in correspondence with a physical unit number portion or column 1430. The physical unit numbers correspond to physical units 1440, including a transfer unit 1450, in a flash memory. The units may be blocks, for example. That is, each map table entry may correspond with one physical unit.

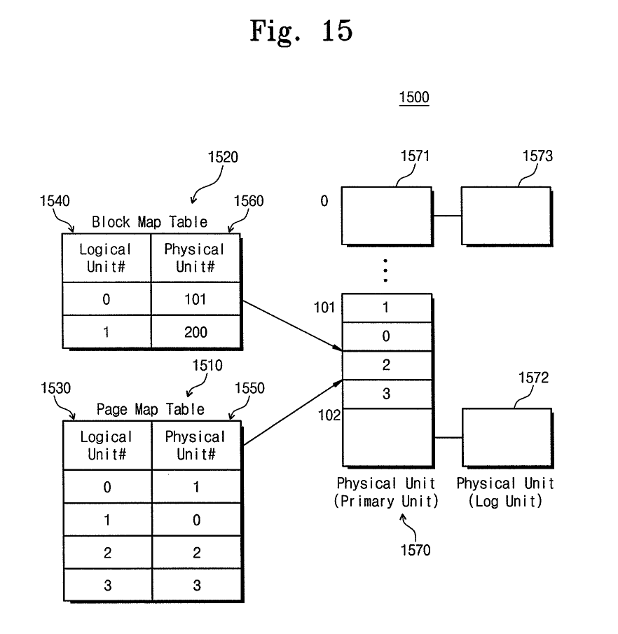

Turning now to FIG. 15, a 1:2 mapping structure is indicated generally by the reference numeral 1500. The 1:2 structure 1500 includes a page map table 1510 and a block map table 1520. The page map table 1510 has a logical page number portion or column 1530 in correspondence with a physical page number portion or column 1550. The block map table 1520 has a logical block number portion or column 1540 in correspondence with a physical block number portion or column 1560.

The physical block and page numbers correspond to physical blocks 1570-1573 and their pages within a physical storage device or flash memory. Here, a physical block number such as 101 from the block map table 1520 points to a physical block 1570, and physical page numbers such as 1, 0, 2 and 3 from the page map table 1510 point to physical pages within the block 1570. The blocks and pages that are directly indicated in the map tables are primary units, and each primary unit may have one additional log unit associated with it to record updates. Thus, primary blocks 1570 and 1571 may be associated with log blocks 1572 and 1573, respectively. That is, each map table entry may correspond with one or two physical units.

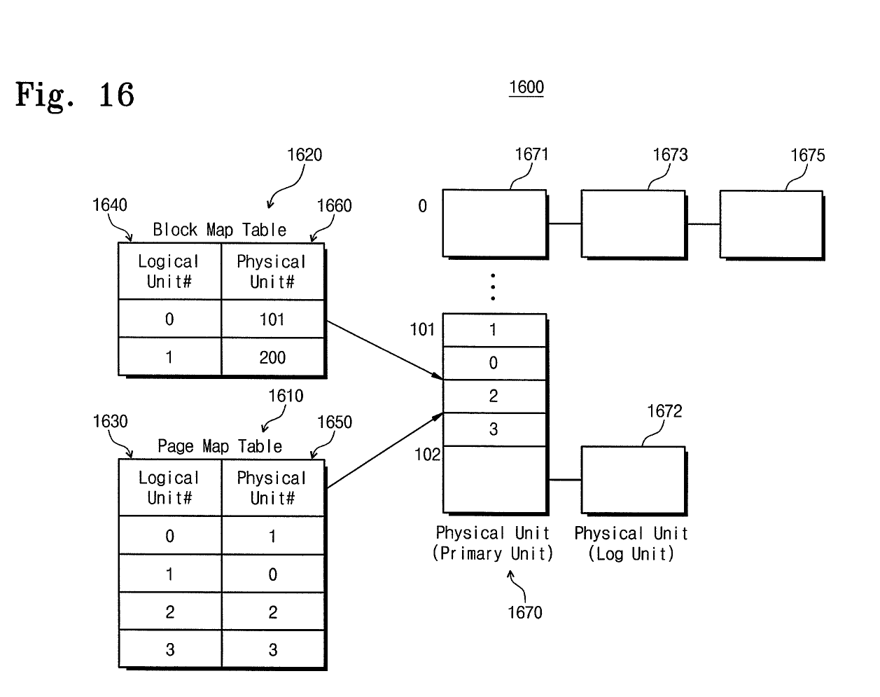

As shown in FIG. 16, a 1:N mapping structure is indicated generally by the reference numeral 1600. The 1:N structure 1600 includes a page map table 1610 and a block map table 1620. The page map table 1610 has a logical page number portion or column 1630 in correspondence with a physical page number portion or column 1650. The block map table 1620 has a logical block number portion or column 1640 in correspondence with a physical block number portion or column 1660.

The physical block and page numbers correspond to physical blocks 1670-1675 and their pages within a physical storage device or flash memory. Here, a physical block number such as 101 from the block map table 1620 points to a physical block 1670, and physical page numbers such as 1, 0, 2 and 3 from the page map table 1610 point to physical pages within the block 1670. The blocks and pages that are directly indicated in the map tables are primary units, and each primary unit may have up to N additional log units associated with it to record updates. Thus, primary block 1671 may be associated with log blocks 1673, 1675 . . . . That is, each mapping table entry may correspond with from one to N physical units. The 1:N mapping structure 1600 uses a delayed merge of the log blocks with the data blocks.

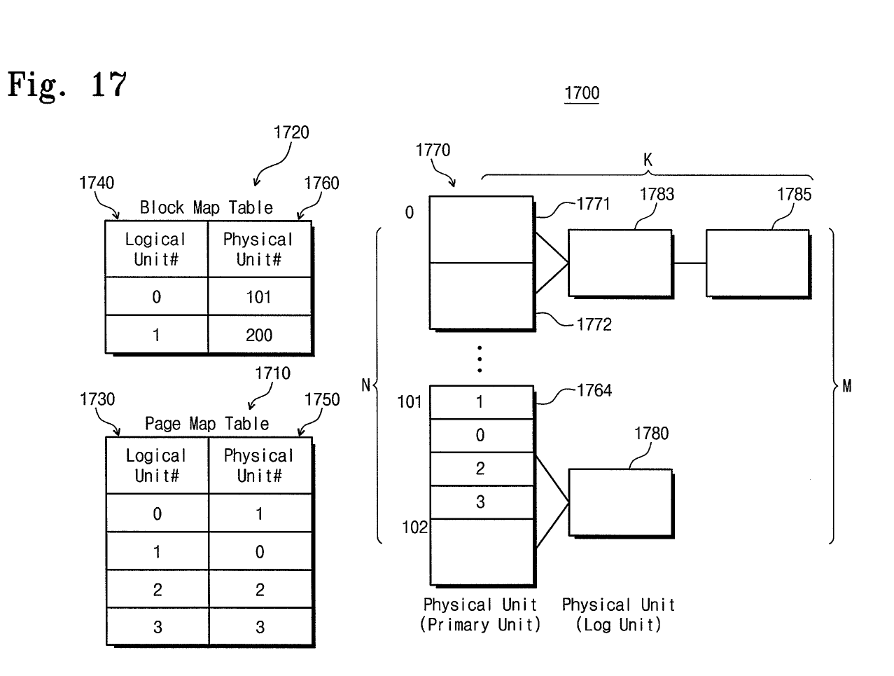

Turning to FIG. 17, an N:M+K mapping structure is indicated generally by the reference numeral 1700. The N:M+K structure 1700 includes a page map table 1710 and a block map table 1720. The page map table 1710 has a logical page number portion or column 1730 in correspondence with a physical page number portion or column 1750. The block map table 1720 has a logical block number portion or column 1740 in correspondence with a physical block number portion or column 1760.

The physical block and page numbers correspond to physical blocks 1769-1775 and their pages within a physical storage device or flash memory. Here, a physical block number such as 101 from the block map table 1720 points to a physical block 1770, and physical page numbers such as 1, 0, 2 and 3 from the page map table 1710 point to physical pages within the block 1770. The blocks and pages that are directly indicated in the map tables are primary units, and each primary unit may be associated with up to K additional chained or grouped log units to record updates. The additional chained or grouped log units may be shared by up to N primary units. In addition, there may be up to M distinct chains or groups of additional log units. Thus, primary blocks 1771 and 1772, which here have physical block numbers 0 and 1 respectively, may both be associated with chained or grouped log blocks 1783 and 1785. In addition, primary blocks 1769 and 1770, which here have physical block numbers 101 and 102, respectively, may both be associated with log block 1780, for example. The N:M+K mapping structure 1700 uses associativity of the log blocks among the data blocks as well as a delayed merge of the log blocks with the data blocks. Here, N is the number of whole user data blocks, M is the number of write buffer or log blocks, and K is the maximum number of delayed merge or log blocks in a log block group (“LBG”), which may be dynamically controlled. A data block group (“DBG”) is associated with each LBG. In this example, each DBG includes two data blocks, but a DOB may include any number of data blocks in alternate embodiments.

A memory “block” is generally the size of an erase unit, and a memory “page” is generally the size of a read/write unit. It shall be understood by those of ordinary skill in the pertinent art that alternate embodiments may use alternate memory unit, block and/or page sizes, which are not limited to those described in the exemplary embodiments. Sectors or other units of arbitrary size may be used in lieu of the units, blocks and/or pages described herein. In hybrid mapping embodiments, for example, it may be preferable to use page mapping for the write buffer or log units, and to use block mapping for the data units, but alternate embodiments may use two or more alternate sized mapping units.

Although illustrative embodiments have been described herein with reference to the accompanying drawings, it is to be understood that the present disclosure is not limited to those precise embodiments, and that various other changes and modifications may be effected therein by those of ordinary skill in the pertinent art without departing from the scope or spirit of the present disclosure. All such changes and modifications are intended to be included within the scope of the present disclosure as set forth in the appended claims.

1. A method of memory mapping comprising:
receiving write data for a logical unit number from a host;
determining which of a plurality of data block groups comprises the logical unit number; and
storing the write data in any unfilled log unit of a log block group corresponding to the determined data block group.

2. A method as defined in claim 1 wherein the size of a unit is a smallest writable number of bits, the size of a block is a smallest erasable number of bits and a plural multiple of writable unit size, and the size of a group is a variable multiple of erasable block size.

3. A method as defined in claim 1 wherein a unit is at least one of a byte, a page or a sector.

4. A method as defined in claim 1 wherein an association between the logical unit number and a physical unit number is saved in a page mapping table.

5. A method as defined in claim 4, the page mapping table further comprising data group numbers each associated with a plurality of logical unit numbers.

6. A method as defined in claim 1 wherein determining comprises modulus arithmetic based on dividing the logical unit number by the number of the plurality of data block groups.

7. A method as defined in claim 1, further comprising initializing the log block group by assigning a free block as a log block in the log block group.

8. A method as defined in claim 7, further comprising expanding the log block group by assigning a free block as the next log block in the log block group.

9. A method as defined in claim 7, further comprising assigning a plurality of free blocks as a corresponding plurality of log blocks in the log block group.

10. A method as defined in claim 1, further comprising assigning a free block as a log block.

11. A method as defined in claim 10, assigning comprising enrolling the log block in a group mapping table.

12. A method as defined in claim 11 wherein the association of the group mapping table is each group to a plurality of physical block numbers for log blocks.

13. A method as defined in claim 10 wherein the log block is used for all data blocks within the data block group.

14. A method as defined in claim 1, further comprising:
receiving a write request for a second logical unit number from the host; and
storing the second logical unit number in association with a second physical unit number in the log block of the log block group.

15. A method as defined in claim 14, storing comprising updating a page mapping table in accordance with new mapping information for the logical unit number.

16. A method as defined in claim 14, further comprising:
checking whether the log block is full, and if so, assigning an additional log block to the log block group for storing further logical unit numbers.

17. A method as defined in claim 16, assigning comprising updating a group mapping table in accordance with new mapping information for the physical block number of the additional log block.

18. A method as defined in claim 16, further comprising:
receiving a write request for a third logical unit number from the host; and
storing the third logical unit number in association with a third physical unit number in an existing log block of the log block group.

19. A method as defined in claim 1, further comprising:
receiving a write request for another logical unit number from the host where the other logical unit number is not included in the first data block group; and
storing the other logical unit number in association with another physical unit number in a log block of another log block group and updating a page mapping table.

20. A method as defined in claim 19, further comprising:
assigning a free block as a log block to create the other log block group corresponding to another data block group that includes the other logical unit number.

21. A method as defined in claim 1 wherein one log block is assigned to all data blocks within a data block group.

22. A method as defined in claim 1 wherein a log block uses a plurality of physical unit numbers.

23. A method as defined in claim 1 wherein the memory comprises at least one of flash memory, DRAM, PRAM, MRAM, FRAM or EEPROM.

24. A method as defined in claim 1 wherein at least one mapping table is organized to map a first plurality of whole user data blocks to a second plurality of log blocks or write buffers with a third plurality of delayed merge blocks.

25. A method as defined in claim 24 wherein the third plurality is dynamically controlled.

26. A method as defined in claim 1 wherein any number of log blocks can be associated with any number of logical blocks.

27. A method as defined in claim 1 wherein the number of log blocks per log block group is greater than one.

28. A method as defined in claim 1 wherein a log block stores write data units for a plurality of data blocks.

29. A memory mapping system comprising:
input means for receiving write data for a logical unit number from a host;
mapping means for determining which of a plurality of data block groups comprises the logical unit number; and
memory means for storing the write data in any unfilled log unit of a log block group corresponding to the determined data block group.

30. A memory mapping system comprising:
at least one logical unit to physical unit map table;
a plurality of data unit groups in signal communication with the at least one map table; and
a plurality of log unit groups, each associated with a corresponding one of the plurality of data unit groups;
wherein updated data for any data unit within one of the plurality of data unit groups is stored in any log unit within the corresponding one of the plurality of log unit groups.
